(19) United States
(12) Patent Application Publication
(10) Pub. No.: US 2026/0277389 A1
(43) Pub. Date: Sep. 17, 2026

(54) USER INTERFACE FOR SEMI-ANONYMOUS INTERACTION

(71) Applicant: Bytedance Technology Ltd., Grand Cayman (KY)

(72) Inventor: Qian Huang, Culver City, CA (US)

(21) Appl. No.: 19/079,207

(22) Filed: Mar. 13, 2025

(51) Int. Cl. G06F 3/04817; G06F 3/0484; G06F 9/451

(52) U.S. Cl. CPC G06F 3/04817; G06F 3/0484; G06F 9/451

(57) ABSTRACT

The present disclosure involves methods, apparatus, and systems for enabling user interface (UI)-based anonymized social interaction. This can include, receiving an input from a second user for an anonymous reply to a post from a first user; storing the input from the second user as a reply in a repository; determining whether the repository comprises more than a predetermined number of replies; and in response to determining that there are a greater number of replies in the repository than the predetermined number of replies: sending at least one of the replies in the repository to the first user, wherein the at least one of the replies is presented anonymously to the first user in a first user interface (UI).

### TECHNICAL FIELD

The present disclosure generally relates to social media interactions that can be temporarily anonymized and an associated user interface.

### BACKGROUND

Social media represents a new mode of human interaction. Users often want to engage with friends or contacts but can feel like they do not know what to say or that they might say the wrong thing. When a user gets no engagement with their post, they might feel embarrassed having posted at all, and may not want to post again. When reading others'posts, users are often curious but do not always respond to posts or actively participate in the conversation.

### SUMMARY

The present disclosure relates to a method, system, and computer-readable storage media for enabling user interface (UI)-based anonymized social interaction. This can include, receiving an input from a second user for an anonymous reply to a post from a first user; storing the input from the second user as a reply in a repository; determining whether the repository comprises more than a predetermined number of replies; and in response to determining that there are a greater number of replies in the repository than the predetermined number of replies: sending at least one of the replies in the repository to the first user, wherein the at least one of the replies is presented anonymously to the first user in a first user interface (UI).

Implementations can optionally include one or more of the following features.

In some instances, the predetermined number of replies is three replies.

In some instances, the anonymous reply is associated with an icon presented in the post.

In some instances, the first UI comprises a first icon and a second icon for associated with each reply, the first icon initiates an anonymous direct message in a second UI with an author of an associated reply, and the second icon generates a new post from the first user, the new post comprising the reply.

In some instances, the second UI comprises an icon which, when selected by the author of the associated reply, reveals a username of the author to the first user.

In some instances, the post from the first user comprises an image and a sticker, the sticker comprises text and wherein the sticker is movable and scalable within the post.

In some instances, the post is generated in a third UI, and the third UI comprises an icon that, when selected, generates a text phrase on the sticker.

In some instances, the text phrase is generated by a generative AI, and wherein an input to the generative AI is the image.

Methods can further include, selecting an interactive icon at a post generation page of an application; providing text to generate a post soliciting anonymous replies; publishing the post to a target audience; receiving three or more replies to the post, wherein a user associated with each reply is masked; selecting a direct message icon associated with a particular masked user; and receiving and indication that a request to message has been sent to the particular masked user.

In some instances, the this includes receiving an indication that the particular masked user accepts the request to message; and opening a direct message interface with the particular masked user.

In some instances, this includes receiving a request from the particular masked user in the direct message interface to guess the identity of the particular masked user; providing a guessed identity in the direct message interface; and in response to the guessed identity being correct, unmasking the particular masked user's identity.

In some instances, the request to guess the identity of the particular masked user specifies a limited number of attempted guesses.

In some instances, the post comprises an image with the text overlayed on the image.

In some instances, the target audience is selected during generation of the post.

According to a second aspect, one or more computer-readable storage media is provided. The one or more computer-readable storage media stores one or more instructions that, when executable by one or more computers, cause the one or more computers to perform the method according to the first aspect or one or more implementations of the first aspect.

According to a third aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect.

While generally described as computer-implemented software embodied on tangible media that processes and transforms the respective data, some or all of the aspects can be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system for enabling user interface (UI)-based anonymized social interaction.

FIG. 2 is a flowchart illustrating an example process for generating and interacting with anonymized social UIs from a poster's perspective.

FIG. 3 is a flowchart illustrating an example process for generating and interacting with anonymized social UIs from a replier's perspective.

FIGS. 4A-D illustrate an example user interface for generating posts with anonymized replies.

FIG. 5 is an example user interface user interface with a post supporting anonymized replies.

FIGS. 6A-C illustrate example UIs for interacting with a post supporting anonymized replies.

FIGS. 7A-D illustrate example UIs for interacting with a post supporting anonymized replies.

Like reference numbers and designations in the various drawings indicate like elements.

### DETAILED DESCRIPTION

This specification relates to methods, apparatuses, and systems for enabling user interface (UI)-based anonymized social interaction. A “secret sticker” icon that can be added to posts is provided, which causes all responses or replies to the post to be anonymous or have usernames, names, profile pictures, etc. masked or otherwise not presented. Being able to solicit anonymous or semi-anonymous responses can reduce pressure to engage, increasing engagement, and encourage honesty in replies since there is less risk associated with an anonymous reply.

Disclosed is a process and UI that enables such communication. It is advantageous in that this can be clearly operated by many users with little to no skill. Security and safety can be maintained by a backend system, while simple and easy to use UI's present the required information in an interesting and new way.

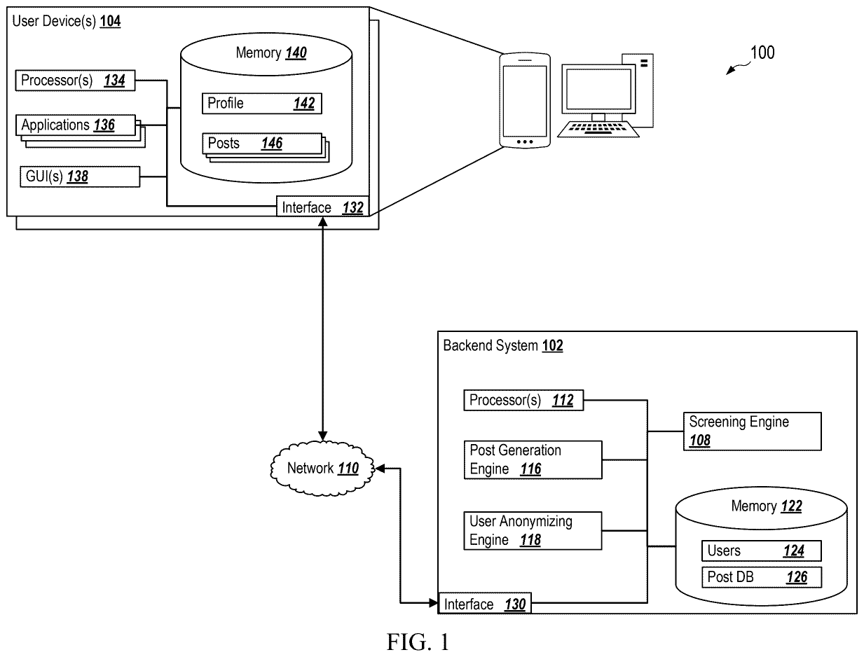

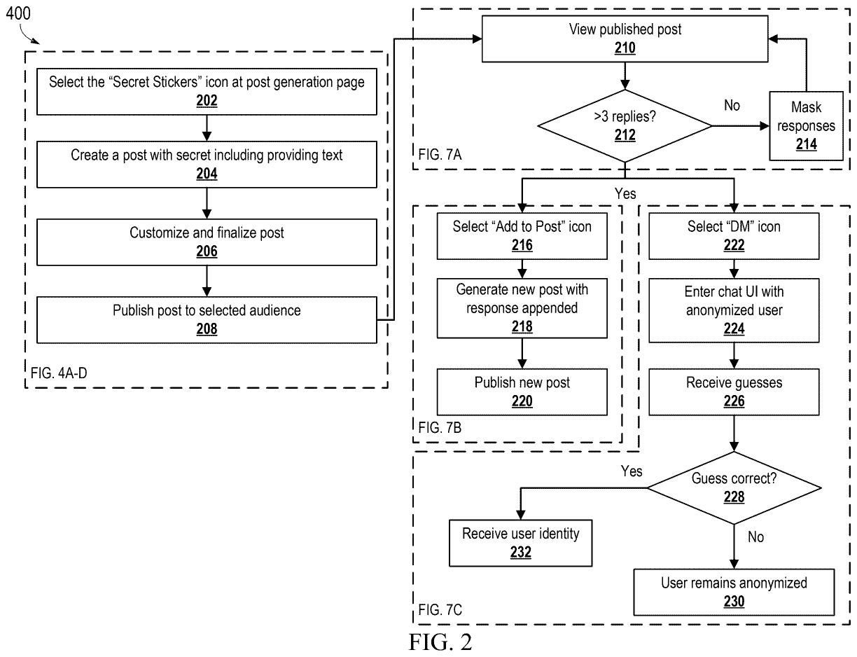

FIG. 1 illustrates a block diagram of an example system 100 for enabling UI based anonymized social interaction. The system 100 includes a backend system 102, one or more user devices 104, and a network 110.

Network 110 facilitates wireless or wireline communications between the components of the system 100 (e.g., between the backend system 102, and the user devices 104), as well as with any other local or remote computers, such as additional mobile devices, clients, servers, or other devices communicably coupled to network 110, including those not illustrated in FIG. 1. In the illustrated environment, the network 110 is depicted as a single network, but can comprise more than one network without departing from the scope of this disclosure, so long as at least a portion of the network 110 can facilitate communications between senders and recipients. In some instances, one or more of the illustrated components (e.g., the screening engine 108 and the memory 122) can be included within or deployed to network 110 or a portion thereof as one or more cloud-based services or operations. The network 110 can be all or a portion of an enterprise or secured network, while in another instance, at least a portion of the network 100 can represent a connection to the Internet. In some instances, a portion of the network 110 can be a virtual private network (VPN). Further, all or a portion of the network 110 can comprise either a wireline or wireless link. Example wireless links can include 802.11a/b/g/n/ac, 802.20, WiMax, LTE, and/or any other appropriate wireless link. In other words, the network 110 encompasses any internal or external network, networks, sub-network, or combination thereof operable to facilitate communications between various computing components inside and outside the illustrated system 100. The network 110 can communicate, for example, Internet Protocol (IP) packets, Frame Relay frames, Asynchronous Transfer Mode (ATM) cells, voice, video, data, and other suitable information between network addresses. The network 110 can also include one or more local area networks (LANs), radio access networks (RANs), metropolitan area networks (MANs), wide area networks (WANs), all or a portion of the Internet, and/or any other communication system or systems at one or more locations.

The backend system 102 can be a server or web-based system that enables generation of user interfaces, and interaction between users and/or user devices 104. The backend system 102 can include one or more processors 112, a screening engine 108, a post generation engine 116, a user anonymizing engine 118, and a memory 122 storing user profiles 124 and a post database 126.

Each of the one or more processors 112 can be a central processing unit (CPU), an application specific integrated circuit (ASIC), a field-programmable gate array (FPGA), or another suitable component. Generally, the processor 112 executes instructions and manipulates data to perform the operations of the backend system 102. Specifically, the processor 112 executes the algorithms and operations described in the illustrated figures, as well as the various software modules and functionality, including the functionality for sending communications to and receiving transmissions from the user devices 104, as well as to other devices and systems. Each processor 112 can have a single or multiple cores, with each core available to host and execute an individual processing thread. Further, the number of, types of, and particular processors 112 used to execute the operations described herein can be dynamically determined based on a number of requests, interactions, and operations associated with the backend system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of fourth-generation programming language (4GL), as well as others.

Memory 122 can represent a single memory or multiple memories. The memory 122 can include any memory or database module and can take the form of volatile or non-volatile memory including, without limitation, magnetic media, optical media, random access memory (RAM), read-only memory (ROM), removable media, or any other suitable local or remote memory component. The memory 122 can store various objects or data, including digital asset data, public keys, user and/or account information, administrative settings, password information, caches, applications, backup data, repositories storing business and/or dynamic information, and any other appropriate information associated with the backend system 102, including any parameters, variables, algorithms, instructions, rules, constraints, or references thereto. Additionally, the memory 112 can store any other appropriate data, such as user profiles 124, posts and replies to posts (e.g., post database 126), firmware logs and policies, firewall policies, a security or access log, print or other reporting files, as well as others. While illustrated within the system 100, memory 122 or any portion thereof, including some or all of the particular illustrated components, can be located remote from the system 100 in some instances, including as a cloud application or repository or as a separate cloud application or repository when the system 100 itself is a cloud-based system.

The screening engine 108 can review posts, comments, replies, or other user content for content that violates terms and conditions of the backend system 102 or otherwise is not wanted. (e.g., “bot” traffic, spam messages, threatening or illegal content, etc.). In some implementations the screening engine 108 includes a rules engine that filters incoming user content in an automated manner. In some implementations one or more AI models are trained to identify content that is to be blocked or filtered. In some implementations, when a user's content is screened, that user can be notified why and provided the opportunity to correct the content. In some implementations, the screening engine 108 provides some content for human review.

The post generation engine 116 can be used to enable user devices 104 to generate new posts using their associated applications 136 and/or GUIs 138. In some implementations, the post generation engine receives requests from the user devices 104 to generate a particular post, with a combination of media (e.g., images, video, text, animations) a target audience (e.g., “friends,” “followers,” “contacts,” “public,” or “private”) and generates the post, hosted at the backend system 102 (e.g., in the Post DB 126) and exposes it to the target audience for consumption.

The user anonymizing engine 118 can be used to make certain responses or interactions with posts anonymous. For example, the anonymizing engine 118 can mask usernames and profiles for certain posts or replace them with randomly generated ones. In some implementations, the anonymizing engine 118 creates a database list with an array of anonymized names or partially encrypts the user data for certain posts, in a manner that enables decryption later and revelation of the anonymized name. For example, a user's posts can be set to be anonymous for the initial 24 hours of the post, and then the user is revealed following the anonymity period. In another implementation, a poster's user information can be encrypted, and then a decryption key provided to certain other users at the poster's request. Those other users can identify the anonymous (or semi-anonymous) poster only if they've been provided the decryption key by the user anonymizing engine 118.

The post database 126 can store user posts, replies, or comments on the posts, as well as metadata associated with those posts such as the date created, views, user activity, and other things. In some implementations, the post database 126 can be exposed to other systems and components, such as applications 136 of user devices 104, where it can be represented as an archive or warehouse of templates for generation of future posts.

Interface 130 is used by the backend system 102 to communicate with other systems in a distributed environment—including within the system 100—connected to the network 110 (e.g., user devices 104, and other systems communicably coupled to the illustrated avatar management system 102 and/or network 110. Generally, the interface 130 includes logic encoded in software and/or hardware in a suitable combination and operable to communicate with the network 110 and other components. More specifically, the interface 130 can include software supporting one or more communication protocols associated with communications such that the network 110 and/or interface's 130 hardware is operable to communicate physical signals within and outside of the illustrated system 100. Still further, the interface 130 can allow the backend system 102 to communicate with the user devices 104, and/or other portions illustrated within the system 100 to perform the operations described herein.

User devices 104 can be computing devices or computers used by one or more users and developers of the software and hardware within system 100. For example, the user devices 104 can interact with the backend system 102 to request or view active or past posts, as well as generate new posts, message other users, or review activity. As used in the present disclosure, the term “computer” or “computing devices” is intended to encompass any suitable processing device. For example, the user devices 104 can be any computer or processing device such as, for example, a blade server, general-purpose personal computer (PC), Mac® workstation, UNIX-based workstation, or any other suitable device. In other words, the present disclosure contemplates computers other than general-purpose computers, as well as computers without conventional operating systems. The user devices 104, in some instances, can be desktop systems, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The user devices 104 can include one or more specific applications 136 executing on the user devices 104 or the user devices 104 can include one or more Web browsers or web applications that can interact with particular applications executing remotely from the user devices 104. User devices 104 can include a memory 140, which can be similar to or different from memory 122 and can store user profiles 142, the user's data or information, as well as posts 146 that have been previously generated. The user devices 104 can include an interface 132 which enables communication with other components of system 100, and can be similar to interface 130.

GUI 138 of the user devices 104 interfaces with at least a portion of the system 100 for any suitable purpose, including generating a visual representation of any particular application or results and/or the content associated with any components of the user devices 104. In particular, the GUI 138 can be used to present posts and comments or allow the user to input responses and generate new content for the backend system 102, as well as to otherwise interact and present information associated with one or more applications. GUI 138 can also be used to view and interact with various web pages, applications, and web services located local or external to the user devices 104. Generally, the GUI 138 provides the user with an efficient and user-friendly presentation of data provided by or communicated within the system. The GUI 138 can include a plurality of customizable frames or views having interactive fields, pull-down lists, and buttons operated by the user. In general, the GUI 138 is often configurable, supports a combination of tables and graphs (e.g., bar, line, pie, and/or status dials), and is able to build real time portals, application windows, and presentations. Therefore, the GUI 138 contemplates any suitable graphical user interface, such as a combination of a generic web browser, a web-enable application, intelligent engine, and command line interface (CLI) that processes information in the platform and efficiently presents the results to the user visually.

FIG. 2 is a flowchart illustrating an example process 200 for generating and interacting with anonymized social UIs from a poster's perspective. The example process 200 can be performed by a system for example, system 100 as described above with respect to FIG. 1. The operations shown in process 200 may not be exhaustive and other operations can be performed as well before, after, or in between any of the illustrated operations. Further, some of the operations may be performed simultaneously or in a different order than shown in FIG. 2. In some implementations, some of the operations may be performed by a computer or multiple computers. The one or more computers the process 200 will be described as being performed by a system of, located in one or more locations, and programmed appropriately in accordance with this specification. For example, one or more of a computation system 900 of FIG. 9, appropriately programmed, can perform the process 200.

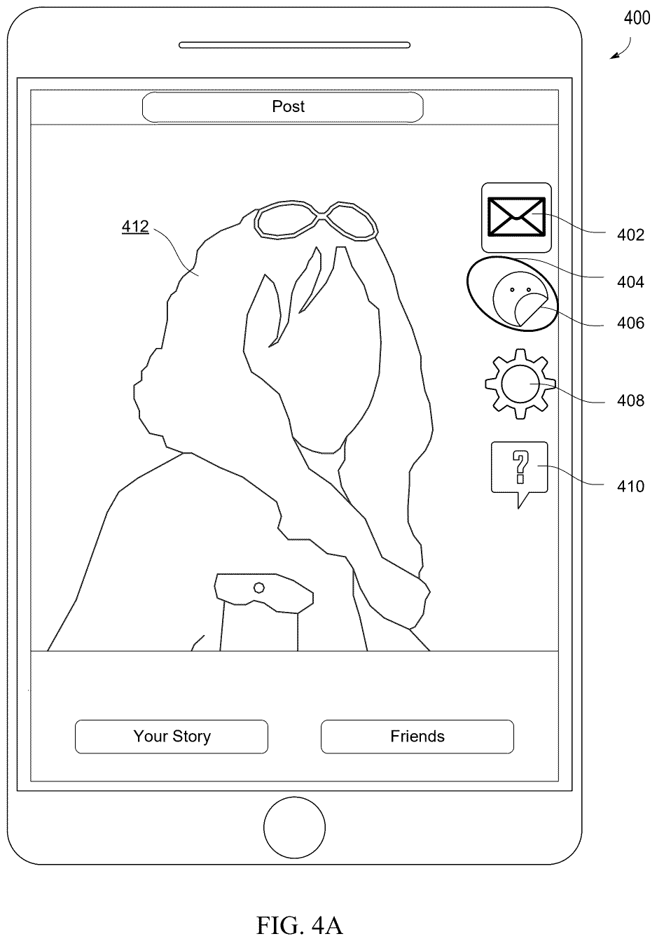

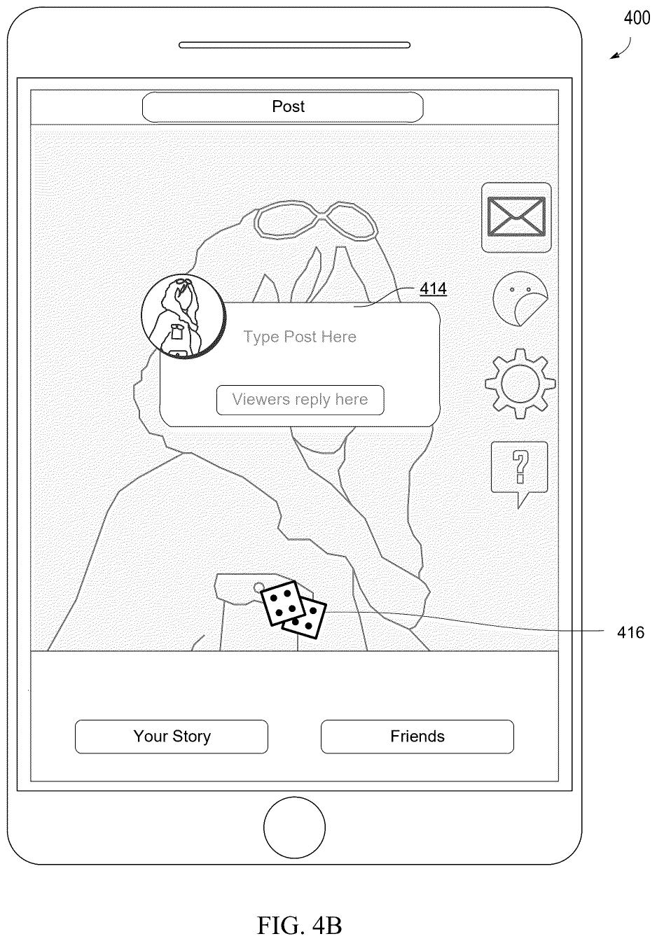

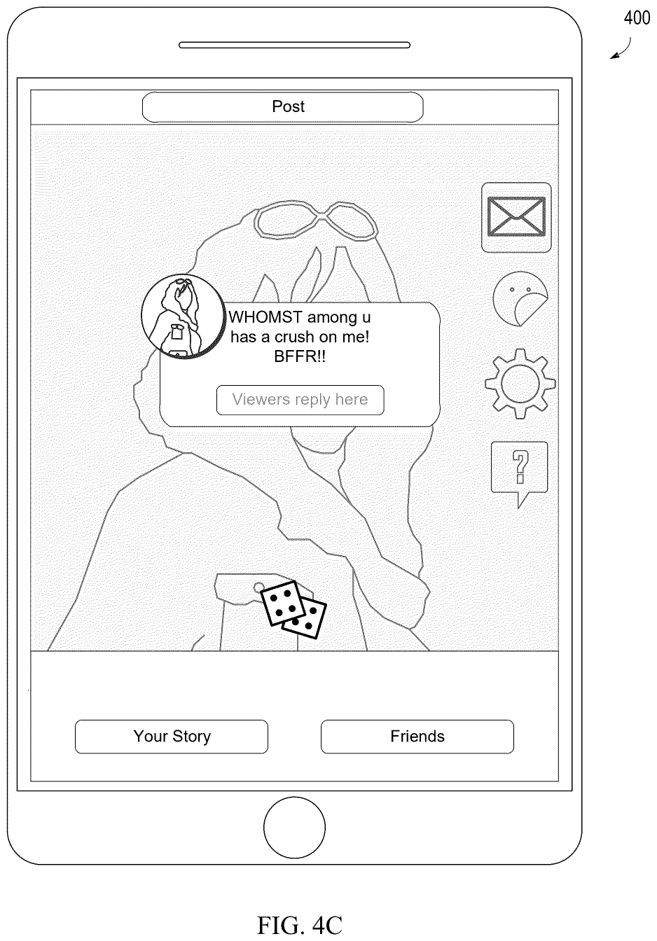

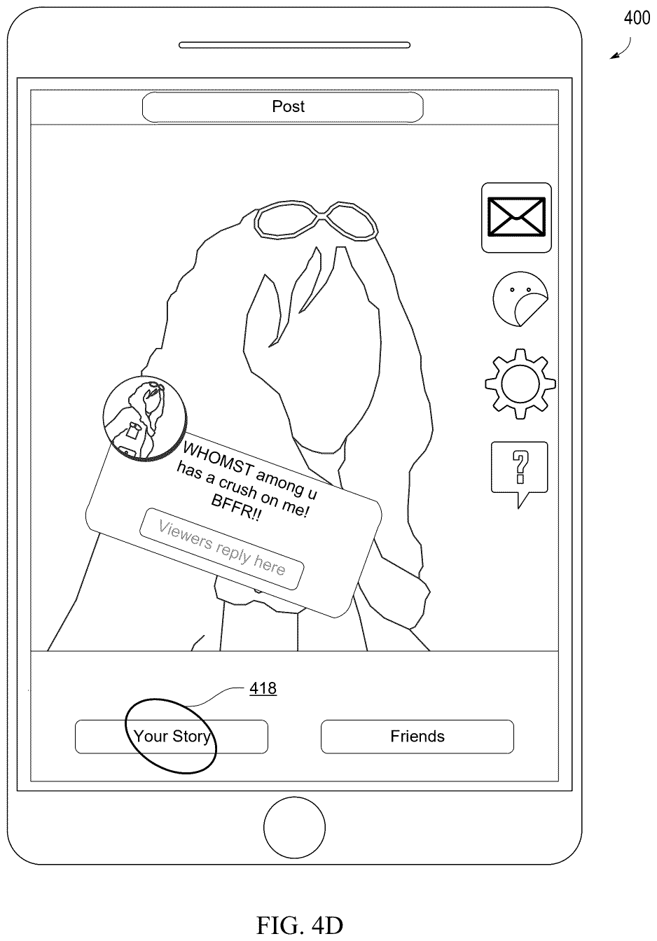

202 through 208 are illustrated in more detail below with example UIs in FIGS. 4A-4D.

At 202, the user, when creating a new post, can press a “secret sticker” icon or otherwise indicate they'd like to create an anonymous feedback mechanism within a post. In some implementations, instead of an icon, this is a default setting or a selection from a dropdown menu. FIG. 4A illustrates an example post generation UI with several icons, including a messenger icon 402, secret sticker icon 406, settings icon 408, help icon 410. UI 400 also includes an image 412, which can be a user selected image, their profile picture, or a live image capture from a camera of the user device (e.g., user device 104 of FIG. 1) among other things. In the illustrated FIG. 4A, the user has pressed (404) on the secret sticker icon 406.

At 204, the user creates a post by overlaying text or other media on an image. FIG. 4B illustrates an example, where a sticker 414 is presented on the image, with an input field for the user to fill out. In some implementations, an automatic input generator 416 icon is provided. If the user selects this, a sticker will be automatically generated and submitted to the user for approval. In some implementations, the automatic generation is a selection from a set of predetermined phrases or posts. In some implementations, the automatic generation is generated by using the image 412 as a prompt to an AI model. FIG. 4C is an example of a sticker where the user has input text on a sticker for their post, asking a question of their followers to be answered anonymously.

At 206, the user customizes and finalizes their post. This can include relocating the sticker, scaling the sticker, reformatting the sticker, re-coloring the sticker, adding subtitles or additional flavor text, or other things. In some implementations, other editing tools are provided, such as image enhancement, animations, replay modifications, or others. FIG. 4D illustrates an example of a customized post. The user in FIG. 4D has rotated and moved the sticker in the post, then presses (418) the “your story” button to finalize the post and publish it on their profile as a “story.” In some implementations, a story is a post that is visible for a limited amount of time before it expires. For example, a story can be a video, image, or series of videos and images (with or without stickers, subtitles, or other modification) that is visible to all of a user's followers for 24 hours, after which it expires and is removed from the user's profile. In some implementations, a user can still access viewership or engagement metrics for a story after the story has expired.

At 208, the post is published to the selected audience. In the example of FIG. 4D, the post was published as a story. In some implementations, it can be published public, private (e.g., to a selected number of people), to friends, followers, colleagues, or to other subgroups. Publishing the post uploads it to a backend system (e.g., backend system 102 of FIG. 1), which hosts it and makes it available to the selected audience.

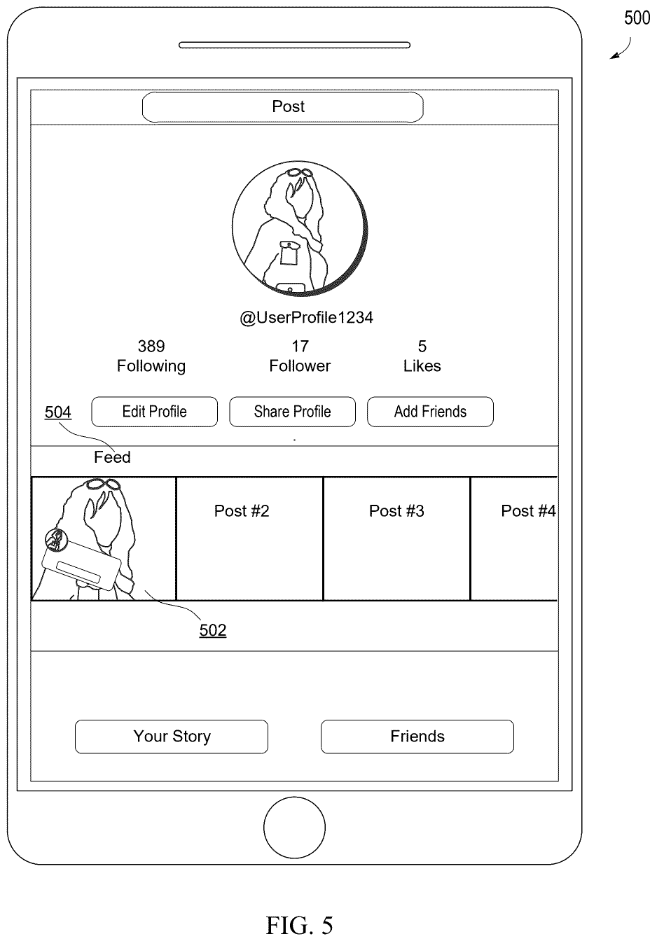

FIG. 5 illustrates an example of a UI showing what a user profile might look like with the story example of FIGS. 4A-D posted. As can be seen, the user's post 502 is presented in a horizontally scrolling feed 504. It should be noted that FIG. 5 is an example only, and other configurations for posts are possible, such as lists, tiles, vertical scrolling, etc. In some implementations, the poster cannot see the number of views or replies for a predetermined time (e.g., 12 hours), preventing further guessing or gaming of the anonymity system.

At 210, when the poster views their published post, they can see certain information. For example, the poster can see how many views the post has, any public views or reactions, and, depending on the number of anonymous replies available, the anonymous replies. At 212 it is determined whether the number of replies is greater than three. While three is used as an example, other numbers (e.g., 2, 5, 10, etc.) can be used. If less than 3 anonymous replies have been made, the replies are masked (214). This prevents a scenario where the poster can easily guess which anonymous replies are from which user based on who has viewed the post and the content of the reply. If there are greater than 3 (or other predetermined number) of replies, the replies can be displayed as well.

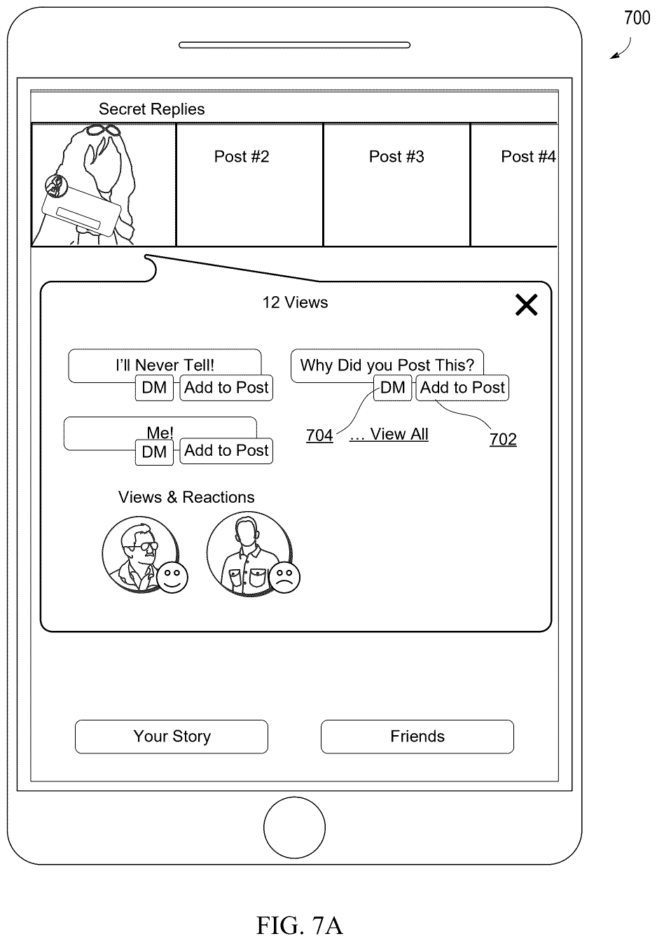

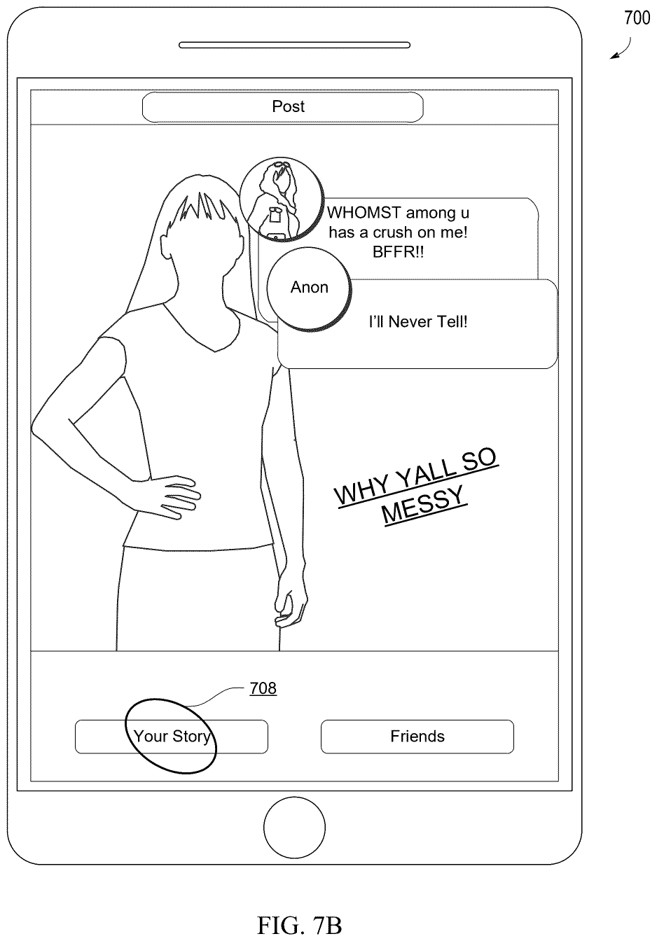

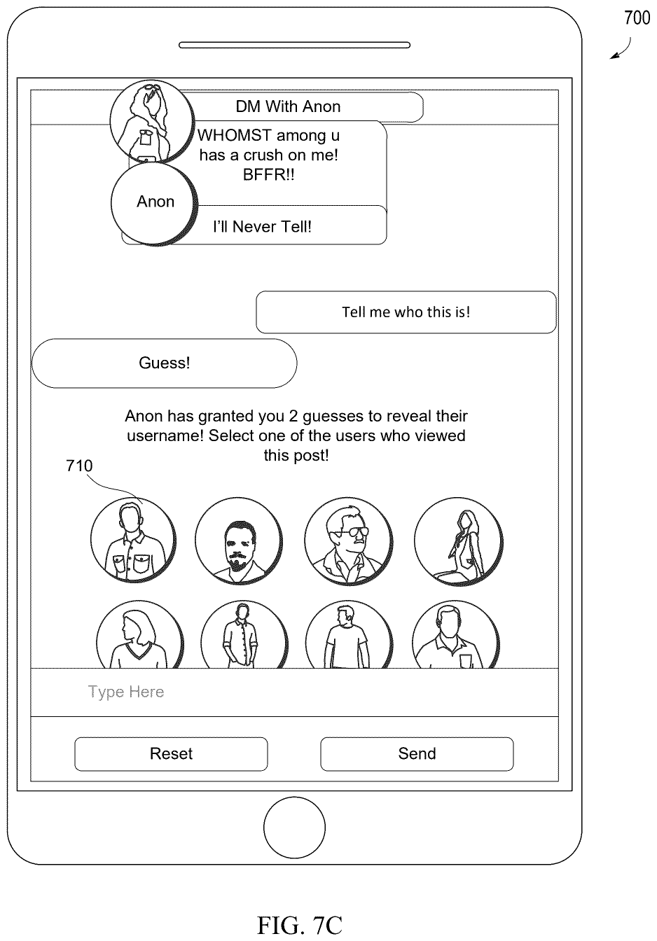

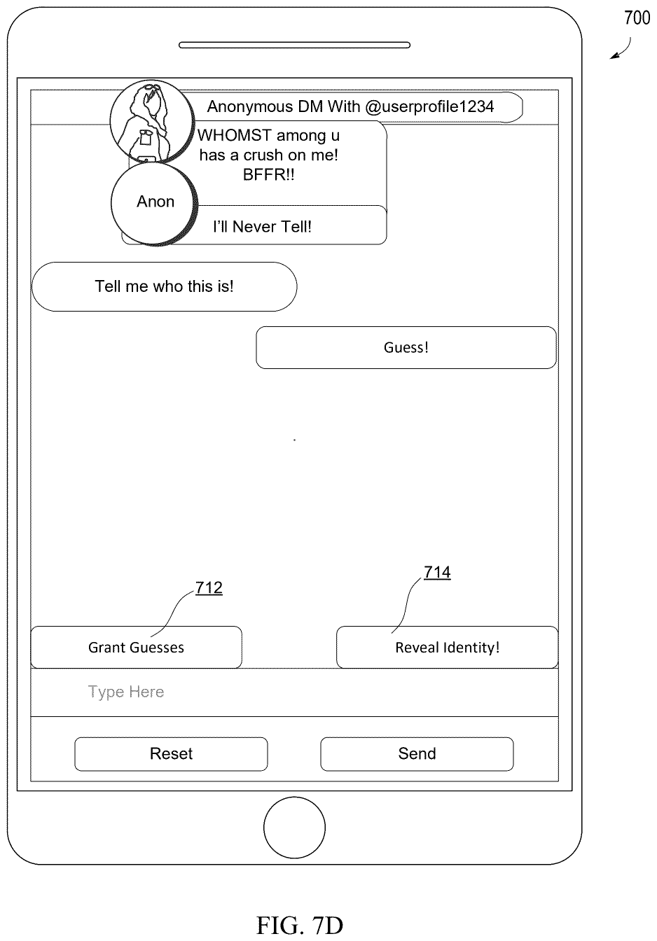

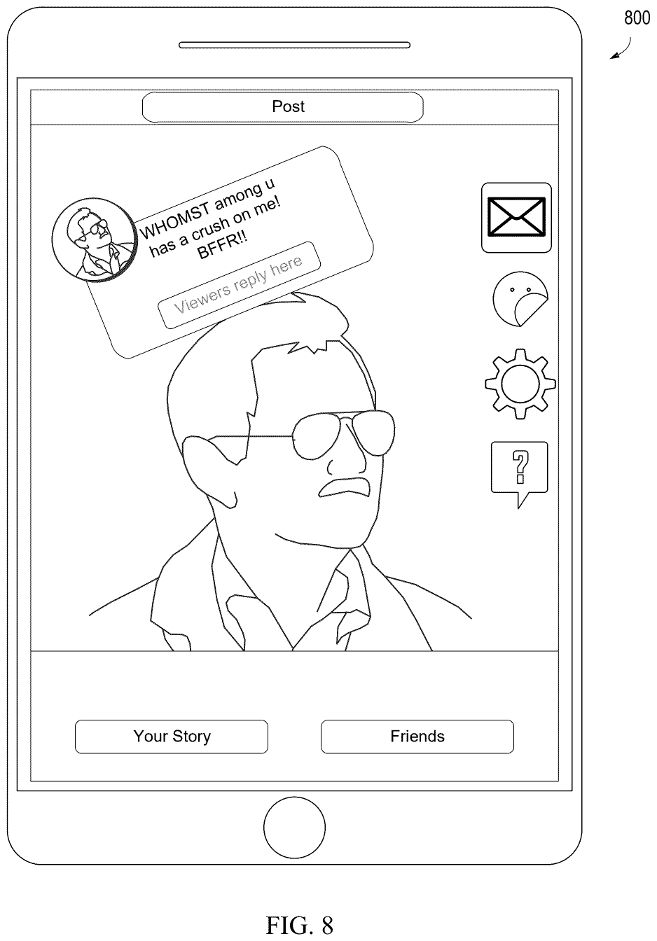

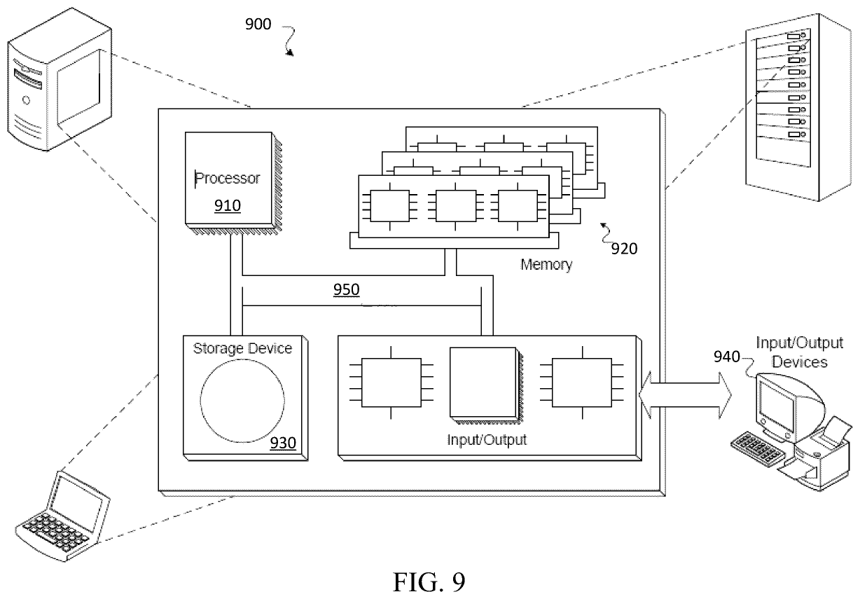

FIG. 7A illustrates an example UI showing that the poster's story has 12 views, received a smile reaction and a frown reaction from some of the viewers, and has some anonymous comments. Each anonymous reply is presented with a DM icon 704 and an Add to Post icon 702. If the user selects the add to post icon 702, process 200 continues at 216.

At 216, the poster has selected the “add to post” icon (e.g., 702 from FIG. 7A). This can bring the poster to a new post generation page, where they can generate a follow up post based on the anonymous reply and the original post.

At 218, the poster generates a new post with the anonymous reply and the original post. FIG. 7B illustrates an example of a new post, with two stickers, one including the original “secret sticker” and the other including the anonymous remark. In some implementations, the poster can add additional images, subtitles (e.g., “WHY YALL SO MESSY”) and other features, customizing it in a process similar to 204-208. By selecting the “your story” icon 708 in FIG. 7B, the poster has generated a new story that is reactive to the anonymous response. Returning to FIG. 2 process 200 continues.

At 220, the new post is published to the poster's profile. In some implementations, this can be similar to 218.

Returning to 222, if the user selects the “DM” or a “messaging” icon (such as DM icon 704), a new UI can be presented (224) that shows a chat with the anonymized user who made the anonymous remark. For example, this can be a chat window or “direct messaging” UI that allows the poster to text with the anonymous replier without revealing who the anonymous replier is. In some implementations, the anonymous replier can block or refuse to respond to the DM request.

At 226, if the anonymous replier chooses to provide the poster with guesses as to their identity, the chat UI can include icons to enable the poster to guess. FIG. 7C is an example of the poster's view of a conversation with an anonymous replier. As illustrated, the anonymous replier has selected an icon and granted the poster with two guesses as to their identity. This can send a notification to the poster and present a list (as indicated by profile icons 710) of users who have viewed the post and might have made the anonymous reply. In the illustrated example, the poster can select (e.g., click, press, or highlight) two of the icons 710, to guess who made the post.

At 228, if the poster's guess(es) are correct, they can receive the anonymous replier's identity (232) which can be in the form of revealing their profile picture and username, and animation highlighting them, or other method.

At 230, if the poster's guesses were incorrect, the anonymous replier remains anonymous. In some implementations, the replier can choose to grant the poster additional guesses or, instead, directly reveal their identity. The anonymous replier can also choose to remain anonymous.

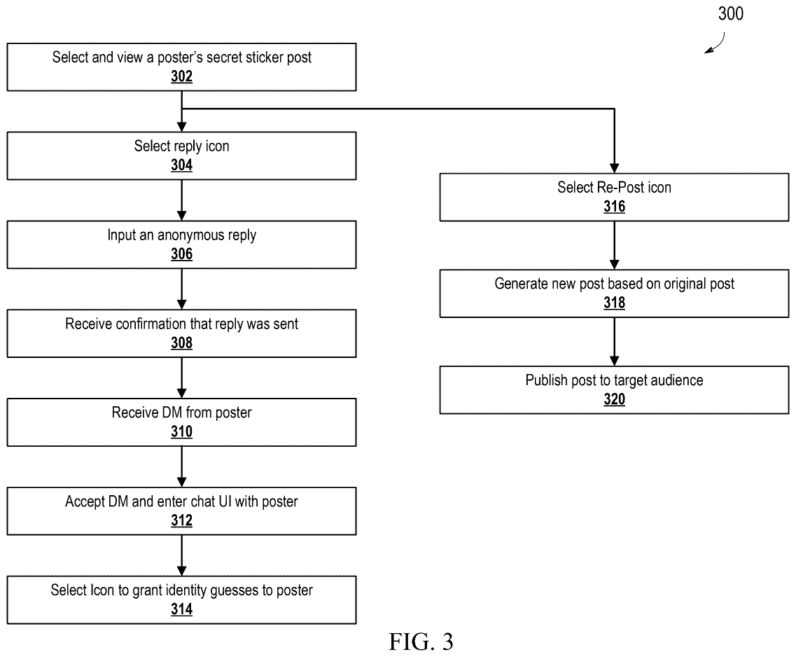

FIG. 3 is a flowchart illustrating an example process 300 for generating and interacting with anonymized social UIs from a replier's perspective. The example process 300 can be performed by a system for example, system 100 as described above with respect to FIG. 1. The operations shown in process 300 may not be exhaustive and other operations can be performed as well before, after, or in between any of the illustrated operations. Further, some of the operations may be performed simultaneously or in a different order than shown in FIG. 3. In some implementations, some of the operations may be performed by a computer or multiple computers. The one or more computers the process 300 will be described as being performed by a system of, located in one or more locations, and programmed appropriately in accordance with this specification. For example, one or more of a computation system 900 of FIG. 9, appropriately programmed, can perform the process 300.

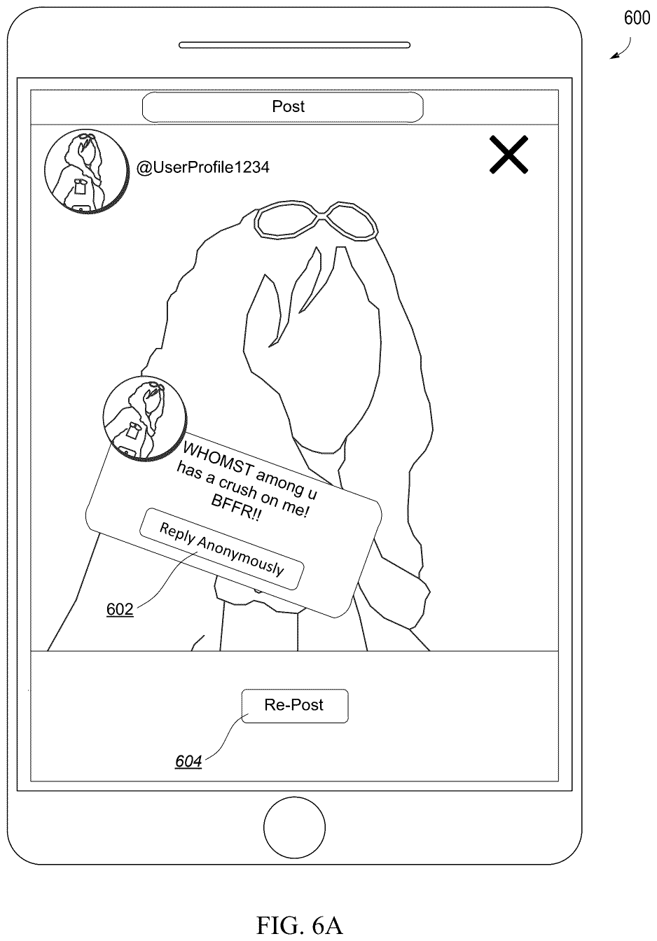

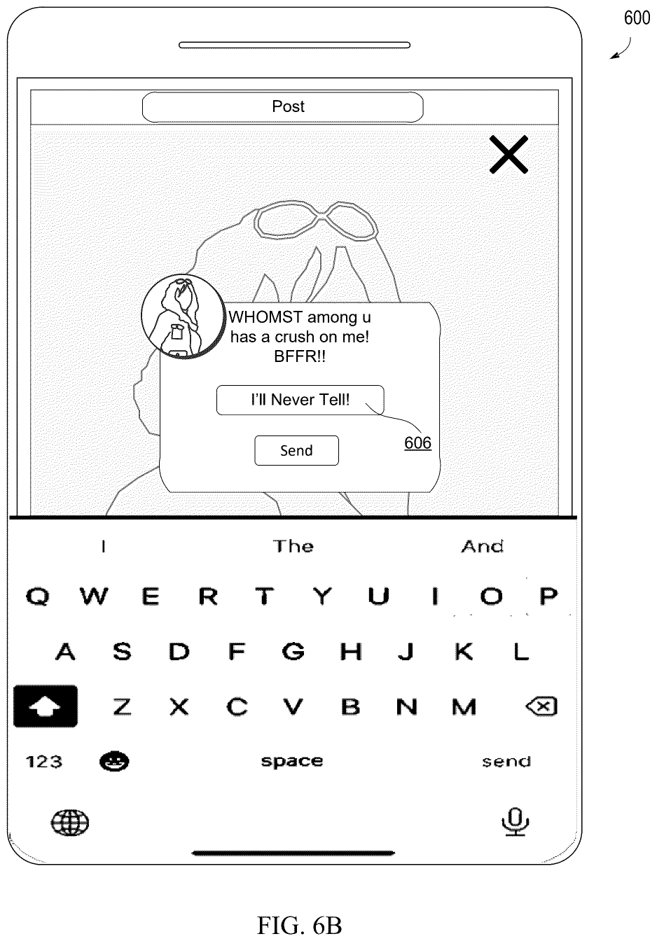

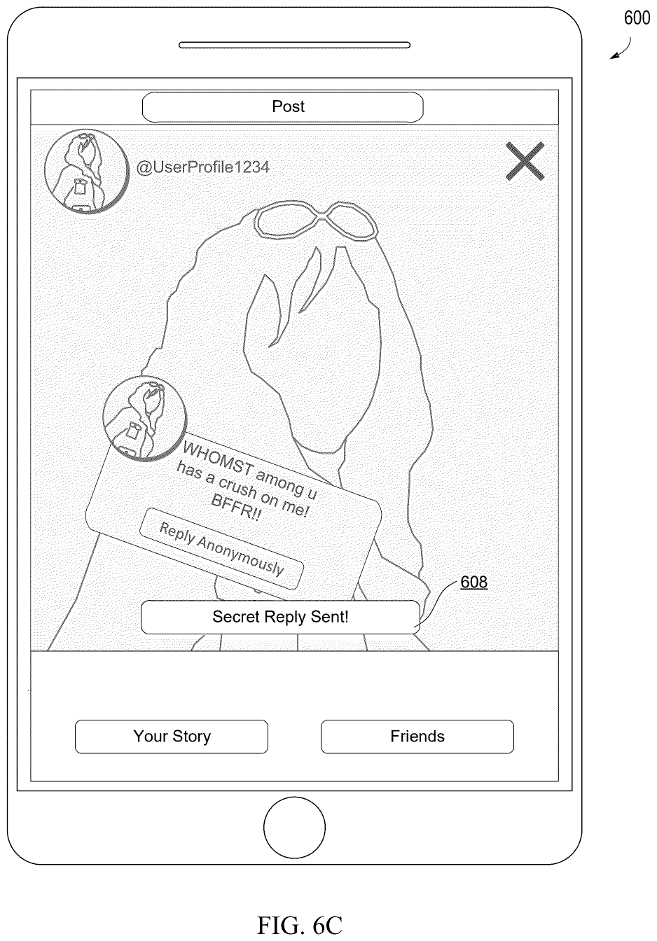

At 302, a replier can select or view a secret sticker post that was generated by a poster (e.g., as described above with respect to FIG. 2). The replier can see the post with the sticker as illustrated in example FIG. 6A. The UI 600 in FIG. 6A illustrates an example “Reply Anonymously” icon 602 and a “Re-Post” icon 604.

At 304, if the replier selects a reply icon (such as, “Reply Anonymously” icon 602), they can be shown another UI where they will be prompted to input an anonymous reply.

At 306, the replier will provide their anonymous reply to the secret sticker. This reply can be input via a user interface, for example a keyboard, touch keyboard, voice input interface, or other user interface can enable the replier to respond to the secret sticker. An example is provided in FIG. 6B, where the replier has responded to the sticker with “I'll Never Tell!” 606.

At 308, upon submitting the reply, the replier can receive a confirmation that their anonymous reply has been sent to the poster. An example confirmation is illustrated in FIG. 6B, which shows a modal window 608 indicating the reply was sent.

At 310, a direct message can be received from the original poster. This can occur, for example, if the poster selects their “DM” icon as described above with respect to FIG. 2 at 222, and FIGS. 7A and 7C.

At 312, upon receipt of the notification of the direct message, the replier can either accept or reject it. If they reject it, no further response is taken. In some implementations, the original poster can be notified that their direct message request was denied. If the replier accepts the direct message request, they can be presented with a chat UI showing the original poster. An example of such a UI is provided in FIG. 7D. The example UI in FIG. 7D includes a “Grant Guesses” icon 712 and a “Reveal Identity” icon 714.

At 314, if the user selects the icon to grant guesses to the original poster, they can be prompted for how many guesses they'd like to grant. In some implementations, they can grant a fixed number (e.g., 2, 5, etc.) or a number per time period (e.g., 1 guess per hour). Alternatively or additionally, the user can select the reveal identity icon, in which case their username and profile picture can be directly shared with the original poster by the backend system. In some implementations, the chat UI illustrated in FIGS. 7C and 7D (from the poster's perspective and the replier's perspective respectively) can be automatically removed or deleted after a predetermined time period (e.g., 24 hours, 7 days, one month, etc.) to reduce required memory storage and enhance user privacy.

Returning to 302, if while viewing the original poster's secret sticker post, the user selects a re-post icon (316) then process 300 can continue at 318.

At 318, a new post is generated by the replier, which can be a copy of the original post except with an image selected by or taken from the replier. An example re-post is illustrated in FIG. 8, where a different user has generated a secret sticker post using the same sticker. In some implementations, the process of generating the new post is similar to 204-208 above, with the provided text being automatically provided when the replier selects the re-post icon.

At 320, the re-post can be published to a target audience, which can be the same as the original post or a different audience. In some implementations, the re-post can be published public, private (e.g., to a selected number of people), to friends, followers, colleagues, or to other subgroups. Publishing the post uploads it to a backend system (e.g., backend system 102 of FIG. 1), which hosts it and makes it available to the selected audience.

FIG. 9 illustrates a schematic diagram of an example computing system 900. The system 900 can be used for the operations described in association with the implementations described herein. For example, the system 900 may be included in computing devices of the one or more online components and/or the one or more offline components. The system 900 includes a processor 910, a memory 920, a storage device 930, and an input/output device 940, which are interconnected using a system bus 950. The processor 910 is capable of processing instructions for execution within the system 900. In some implementations, the processor 910 is a single-threaded processor. The processor 910 is a multi-threaded processor. The processor 910 is capable of processing instructions stored in the memory 920 or on the storage device 930 to display graphical information for a user interface on the input/output device 940.

The memory 920 stores information within the system 900. In some implementations, the memory 920 is a computer-readable medium. The memory 920 can be a volatile memory unit or a non-volatile memory unit. The storage device 930 is capable of providing mass storage for the system 900. The storage device 930 is a computer-readable medium. The storage device 930 may be a floppy disk device, a hard disk device, an optical disk device, or a tape device. The input/output device 940 provides input/output operations for the system 900. The input/output device 940 includes a keyboard and/or pointing device. The input/output device 940 includes a display unit for displaying graphical user interfaces.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition to, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors (or both) or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to (or both), one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship with each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required to be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations but should be defined only in accordance with the following claims and their equivalents. Accordingly, other implementations also are within the scope of the claims.

What is claimed is:

1. A computer-implemented method comprising:
receiving an input from a second user for an anonymous reply to a post from a first user;
storing the input from the second user as a reply in a repository;
determining whether the repository comprises more than a predetermined number of replies; and
in response to determining that there are a greater number of replies in the repository than the predetermined number of replies:
sending at least one of the replies in the repository to the first user, wherein the at least one of the replies is presented anonymously to the first user in a first user interface (UI).

2. The computer-implemented method of claim 1, wherein the predetermined number of replies is three replies.

3. The computer-implemented method of claim 1, wherein the anonymous reply is associated with an icon presented in the post.

4. The computer-implemented method of claim 1, wherein the first UI comprises a first icon and a second icon for associated with each reply, wherein the first icon initiates an anonymous direct message in a second UI with an author of an associated reply, and wherein the second icon generates a new post from the first user, the new post comprising the reply.

5. The computer-implemented method of claim 4, wherein the second UI comprises an icon which, when selected by the author of the associated reply, reveals a username of the author to the first user.

6. The computer-implemented method of claim 1, wherein the post from the first user comprises an image and a sticker, wherein the sticker comprises text and wherein the sticker is movable and scalable within the post.

7. The computer-implemented method of claim 6, wherein the post is generated in a third UI, and wherein the third UI comprises an icon that, when selected, generates a text phrase on the sticker.

8. The computer-implemented method of claim 7, wherein the text phrase is generated by a generative AI, and wherein an input to the generative AI is the image.

9. A non-transitory, computer-readable medium storing one or more instructions executable by a computer system to perform one or more operations, comprising:
receiving an input from a second user for anonymous replying to a post from a first user;
storing the input from the second user as a reply in a repository;
determining whether the repository comprises more than a predetermined number of replies; and
in response to determining that there are a greater number of replies in the repository than the predetermined number of replies:
sending at least one of the replies in the repository to the first user, wherein the at least one of the replies is presented anonymously to the first user in a first user interface (UI).

10. The non-transitory, computer-readable medium of claim 9, wherein the anonymous replying is associated with an icon presenting in the post.

11. The non-transitory, computer-readable medium of claim 9, wherein the first UI comprises a first icon and a second icon for associated with each reply, wherein the first icon initiates an anonymous direct message in a second UI with an author of an associated reply, and wherein the second icon generates a new post from the first user, the new post comprising the reply.

12. The non-transitory, computer-readable medium of claim 11, wherein the second UI comprises an icon which, when selected by the author of the associated reply, reveals a username of the author to the first user.

13. The non-transitory, computer-readable medium of claim 9, wherein the post from the first user comprises an image and a sticker, wherein the sticker comprises text and wherein the sticker is movable and scalable within the post.

14. The non-transitory, computer-readable medium of claim 13, wherein the post is generated in a third UI, and wherein the third UI comprises an icon that, when selected, generates a text phrase by a generative AI on the sticker.

15. A computer-implemented method comprising:
selecting an interactive icon at a post generation page of an application;
providing text to generate a post soliciting anonymous replies;
publishing the post to a target audience;
receiving more than one replies to the post, wherein a user associated with each reply is masked;
selecting a direct message icon associated with a particular masked user; and
receiving an indication that a request to message has been sent to the particular masked user.

16. The computer-implemented method of claim 15, comprising:
receiving an indication that the particular masked user accepts the request to message; and
opening a direct message interface with the particular masked user.

17. The computer-implemented method of claim 16, comprising:
receiving, from the particular masked user in the direct message interface, a request to guess an identity of the particular masked user;
providing a guessed identity in the direct message interface; and
in response to the guessed identity being correct, unmasking the identity of the particular masked user.

18. The computer-implemented method of claim 17, wherein the request to guess the identity of the particular masked user specifies a limited number of attempted guesses.

19. The computer-implemented method of claim 15, wherein the post comprises an image with the text overlayed on the image.

20. The computer-implemented method of claim 15, wherein the target audience is selected during generation of the post.
